(19) United States
(12) Patent Application Publication
(10) Pub. No.: US 2025/0276754 A1
(43) Pub. Date: Sep. 4, 2025

(54) Leaning Vehicle

(71) Applicant: Bayerische Motoren Werke Aktiengesellschaft, Muenchen (DE)

(72) Inventor: Sebastien MARTIN, Muenchen (DE)

(21) Appl. No.: 18/859,755

(22) PCT Filed: Jun. 27, 2023
(86) PCT No.: PCT/EP2023/067442

§ 371 Date: Oct. 24, 2024

(30) Foreign Application Priority Data
Jul. 22, 2022 (DE) 10 2022 118 407.2

(51) Int. Cl. B62J 17/10

(52) U.S. Cl. CPC B62J 17/10

(57) ABSTRACT

A leaning vehicle comprising a housing body which is arranged substantially between a front wheel and a rear wheel and comprising at least one air guiding device which comprises at least one air guiding unit that is arranged on or in the housing body and comprises an air guiding channel running on or through the housing body, wherein the air guiding channel has an inlet which is arranged on a first face of the housing body and via which air can be introduced into the air guiding channel, and the air guiding channel has an outlet which is arranged on a second face of the housing body lying opposite the first face of the housing body and via which air can flow out of the air guiding channel.

### BACKGROUND AND SUMMARY

This disclosure relates to a tilting vehicle.

In the case of tilting vehicles, it is known practice to adopt an inclined position when the tilting vehicle is cornering. This is due to the fact that, when a tilting vehicle is cornering, negative centrifugal forces that must be compensated by the inclined position arise.

The higher the speed at which the tilting vehicle is cornering is, the higher the negative centrifugal forces are and the more inclined the position necessary to compensate them is.

In the present case, centrifugal force is understood to mean all forces related to driving dynamics and aerodynamics that arise on the tilting vehicle while it is cornering.

In this respect, it has been found to be disadvantageous, in particular if the tilting vehicle comprises a racing tilting vehicle, such as a racing motorbike, that a maximum possible cornering speed is limited. The maximum possible cornering speed depends, among other things, on a maximum possible inclined position of the tilting vehicle in which the tilting vehicle can still be operated with road safety.

An object of an exemplary embodiment of the disclosure is to propose a tilting vehicle in the case of which the tilting vehicle can be operated with an elevated cornering speed.

This object is achieved by a tilting vehicle having a housing body arranged substantially between a front wheel and a rear wheel and having at least one air guiding device, which comprises at least one air guiding unit, which is arranged on or in the housing body and comprises an air guiding duct running on or through the housing body, wherein the air guiding duct has an inlet, which is arranged on a first side of the housing body and via which air can flow into the air guiding duct, and wherein the air guiding duct has an outlet, which is arranged on a second side of the housing body situated opposite the first side of the housing body and via which air can flow out of the air guiding duct.

Since the tilting vehicle comprises an air guiding device, in the case of which one side of the housing body is connected to another side of the housing body via the air guiding duct, it is possible for fluid, in particular air, to pass from the first side of the housing body to the second side of the housing body.

This has proven advantageous in particular when cornering, in the course of which the housing body acts like a profile and experiences aerodynamic lift. When the tilting vehicle is cornering, a first side of the housing body faces toward an underlying surface and a second side of the housing body faces away from the underlying surface.

As a result of this, flow can circulate at a different flow velocity around the first side of the housing body than around the second side of the housing body. In terms of flow mechanics, this means that, in the event of a prevailing approximately identical total pressure, the static pressure component on the second side of the housing body is lower than the static pressure component on the first side of the housing body. As a result, a flow is established through the air guiding duct from the first side of the housing body toward the second side of the housing body, with the air exiting the outlet like a free jet via the outlet. The free jet causes a pulse, at least a certain component of which counteracts the centrifugal force, to act on the housing body, in particular on the tilting vehicle.

The total pressure is composed of the sum of the static pressure and the dynamic pressure. The total pressure on the first side of the housing body may correspond to the total pressure on the second side of the housing body.

If the tilting vehicle on one side is tilting toward the carriageway, an unsymmetrical flow around the body is generally produced. This can cause flow detachments on that side of the tilting vehicle that experiences free flow. On the carriageway side, the flow is generally attached, because it is “squeezed” by the carriageway and the tilting vehicle.

As a result, there may be differences in the total pressure of the two sides.

Since the tilting vehicle comprises the air guiding device, which makes it possible to generate a pulse counter to the centrifugal force by way of a free jet, the driver of the tilting vehicle can counteract the centrifugal force that acts during cornering with less of an inclined position. This enables cornering with elevated speeds.

If the tilting vehicle is driving straight ahead, flow circulates around the first side of the housing body and the second side of the housing body at an identical flow-circulation velocity, such that no fluid flow, in particular air flow, is established in the air guiding duct.

“Housing body arranged substantially between a front wheel and a rear wheel,” as used herein, is understood to mean that the housing body is arranged without overlapping the front wheel and/or the rear wheel with respect to a longitudinal axis of the tilting vehicle or that the housing body completely or partially overlaps the front wheel and/or the rear wheel with respect to the longitudinal axis of the tilting vehicle.

A tilting vehicle is understood to mean bicycles, motorbikes or motor vehicles similar to motorbikes, such as motor scooters, in particular two-, three- or four-wheeled motor scooters, scooters, tiltable trikes, quad bikes or the like.

In the present case, centrifugal force is understood to mean all forces relating to driving dynamics and aerodynamics that arise on the tilting vehicle while it is cornering.

The air flowing out of the outlet flows along a main flow direction out of the outlet. Here, that component counteracting the centrifugal force comprises a horizontally running component of the main flow direction.

The horizontally running component of the main flow direction can be increased if the air guiding duct and/or the outlet has a contour which makes it possible to deflect air that flows into the air guiding duct via the inlet and is intended to flow out of the outlet into a main flow direction, which runs at an inclination to the surface of the second side of the housing body and in particular is directed toward an underlying surface.

If the tilting vehicle is cornering, in such a case the main flow direction is aligned running parallel or at an inclination to a horizontal, and the impulse force of the air exiting from the outlet that counteracts the centrifugal force is at its highest.

In principle, it is conceivable for the inlet and the outlet to be at the same height with respect to a vehicle longitudinal axis. In such a case, the inlet, outlet and air guiding duct may run substantially parallel to a transverse axis of the tilting vehicle. Owing to the flow conditions, it is also conceivable for the outlet to be able to be upstream of the inlet along the longitudinal axis. It is also conceivable for the inlet and outlet to be on the same side with respect to the central axis of the tilting vehicle.

In order to avoid flow losses within the air guiding duct, in particular owing to flow deflection, it has proven advantageous if the inlet and the outlet of the air guiding unit are arranged offset from one another with respect to a vehicle longitudinal axis, in particular if the inlet has a smaller spacing from the front wheel than the outlet does.

In addition, it has proven to be advantageous if the inlet and the outlet of the air guiding unit are arranged offset from one another with respect to a vehicle vertical axis.

This makes it possible to arrange the inlet and outlet at a location of the housing body that is not covered by a user of the tilting vehicle when the tilting vehicle is in operation.

In addition, in such a case it becomes possible to position the air exiting from the outlet in a free jet at a location of the tilting vehicle that gives rise to no moment, or only a low moment, that influences the stability of the tilting vehicle.

Frictional and deflectional losses within the air guiding duct can be further reduced if the air guiding duct has an arcuate shape.

In order to increase the flow velocity with which the air exits the outlet like a free jet on the second side of the housing body, it has proven advantageous if the air guiding duct has a cross section which decreases between the inlet and outlet, from the inlet toward the outlet.

The inlet may for example have a cross section which comprises 5000 mm². The outlet may have a cross section of 1000-2000 mm².

To calculate the flow velocity at the outlet, Bernoulli's principle can be applied from the inlet toward the outlet. Here, the retention of mass and/or volume must be taken into account. As the cross-section tapers, the exit velocity at the outlet increases in such a case.

The exit velocity of the air at the outlet can be further increased if the outlet has a nozzle-like contour.

In addition, embodiments of the tilting vehicle are conceivable in which the inlet has an opening which steplessly continues an outer surface of the housing body or in which the inlet comprises a funnel-like inlet, which projects beyond the outer surface of the housing body.

If the inlet has an opening which steplessly continues an outer surface of the housing body, a flow circulating around the tilting vehicle is not influenced or is only slightly influenced. In addition, a user of the tilting vehicle is not hampered in sitting on the tilting vehicle in such a case.

If the inlet comprises a funnel-like inlet, which projects beyond the outer surface of the housing body, a mass flow transported through the air guiding duct can be further increased.

In principle, it is conceivable for the tilting vehicle to comprise only a single air guiding device. It can be used in particular both when cornering to the left and when cornering to the right, if the air guiding duct is extended substantially parallel to a transverse axis of the tilting vehicle.

In order, however, to be able to counteract the acting centrifugal forces both when cornering to the left and when cornering to the right in individually improved fashion, it has proven advantageous if the air guiding device comprises at least two air guiding units, which are arranged running mirror-symmetrically to one another with respect to a plane of symmetry running through the vehicle vertical axis and the vehicle longitudinal axis.

If the air guiding device of the tilting vehicle comprises at least two air guiding units, in embodiments of the tilting vehicle it may be provided that the air guiding ducts of the at least two air guiding units cross one another or that the at least two air guiding units run with their air guiding ducts at a spacing from one another.

If the air guiding ducts of the at least two air guiding units cross one another, the air guiding device can be arranged in or on the housing body compactly and in a way that takes up less space. If the at least two air guiding units run with their air guiding ducts at a spacing from one another, an influence when flow is circulating from the inlet to the outlet is reduced by the respective other air guiding duct.

### BRIEF DESCRIPTION OF THE DRAWING

Further features, details and advantages of the disclosure emerge from the pictorial illustration and subsequent description of a preferred embodiment of the tilting vehicle.

FIG. 1 shows a schematic, sectional plan view of an exemplary embodiment of the tilting vehicle.

### DETAILED DESCRIPTION OF THE DRAWING

The figure shows a tilting vehicle provided overall with the reference sign 2. It comprises a front wheel 4 and a rear wheel 6. A housing body 8 of the tilting vehicle 2 is arranged between the front wheel 4 and the rear wheel 6.

In addition, the tilting vehicle 2 comprises an air guiding device 10, which in the exemplary embodiment illustrated in the figure comprises two air guiding units 12. The air guiding units 12 each comprise an air guiding duct 14 with a respective inlet 16 and outlet 18.

Each inlet 16 is arranged on a respective first side of the housing body 8. By way of the respective inlet 16, air can flow in through the air guiding duct 14. The outlets 18 are each arranged on a second side of the housing body 8 situated opposite the first side of the housing body 8. Via the outlets 18, air can flow out of each air guiding duct 14.

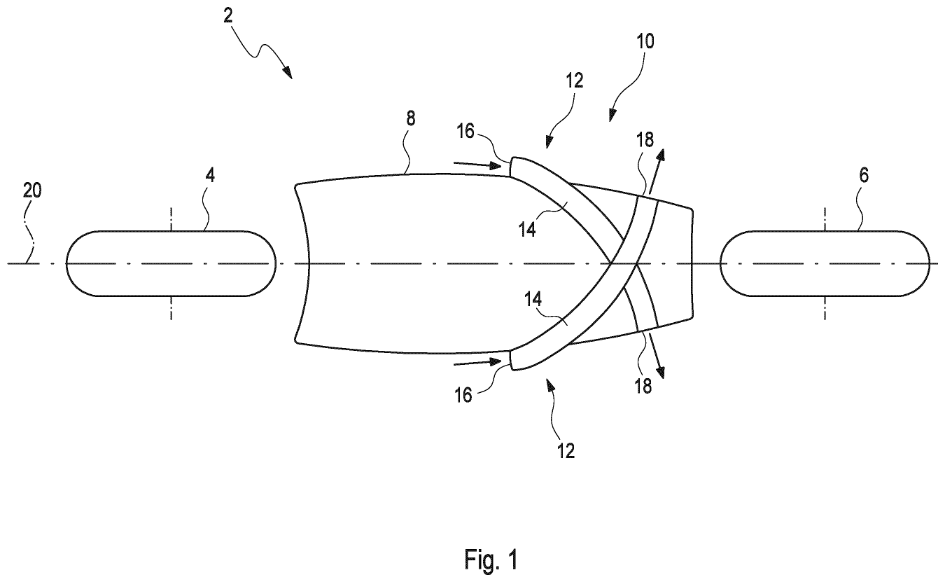

In the exemplary embodiment shown in FIG. 1, the respective inlets 16 are arranged offset from the associated outlets 18 with respect to a vehicle longitudinal axis 20. In this respect, the inlets 16 have a smaller spacing from the front wheel 4 than the outlets 18 do.

The air guiding ducts 14 have an arcuate shape. In addition, the air guiding ducts 14 shown in FIG. 1 have a respective contour which becomes smaller from the inlet 16 toward the outlet 18.

In addition, the inlets 16 are designed such that they project beyond the outer surface of the housing body 8.

The air guiding units 12 of the air guiding device 10 are arranged running mirror-symmetrically to one another with respect to the vehicle longitudinal axis 20.

The following text will briefly describe the mode of operation of the tilting vehicle 2 according to the disclosure:

When the tilting vehicle 2 is driving straight ahead, ambient air flows around the housing body 8 on both sides in the same direction and with the same speed. The air guiding device 10 does not have a function in such a case, and/or the technical effect of the air guiding device 10 is nullified by the two air guiding units 12.

When the tilting vehicle 2 is cornering, different flow-circulation speeds are established on the two sides of the housing body 8. Flow circulates in such a case around the housing body 8, which has properties like a supporting profile. On a first side of the housing body 8 that is closest to an underlying surface when cornering, in such a case the flow-circulation speed is reduced with respect to the opposite side, which faces away from the underlying surface.

The static pressure on the first side of the housing body 8 is elevated with respect to the static pressure on the second side of the housing body 8. In such a case, air flows through that air guiding unit 12 of the air guiding device 10 that has its inlet 16 on the first side, i.e. the side facing toward the underlying surface, owing to the pressure difference between the first side and the second side.

Within the air guiding duct 14, in such a case the air is deflected and blown out of the outlet 18 like a free jet. The resulting thrust counteracts the centrifugal force at least with a certain component, specifically with its movement vector parallel to a horizontal.

When the tilting vehicle 2 changes from cornering with a first rolling direction to cornering with the opposite rolling direction, in such a case the oppositely situated air guiding unit 12 is active.

The features of the disclosure that are disclosed in the above description, in the claims and in the drawing can be essential both individually and in any desired combination in the implementation of the disclosure in its various embodiments within the scope of protection of the following claims.

### LIST OF REFERENCE SIGNS

2 Tilting vehicle
4 Front wheel
6 Rear wheel
8 Housing body
10 Air guiding device
12 Air guiding unit
14 Air guiding duct
16 Inlet
18 Outlet
20 Vehicle longitudinal axis

1.-10. (canceled)

11. A tilting vehicle comprising:
a housing body arranged substantially between a front wheel and a rear wheel and having at least one air guiding device, the air guiding device comprising at least one air guiding unit, which is arranged on or in the housing body and which comprises an air guiding duct running on or through the housing body,
wherein the air guiding duct has an inlet, which is arranged on a first side of the housing body and via which air can flow into the air guiding duct, and
wherein the air guiding duct has an outlet, which is arranged on a second side of the housing body situated opposite the first side of the housing body and via which air can flow out of the air guiding duct.

12. The tilting vehicle according to claim 11, wherein the air guiding duct and/or the outlet have a contour which makes it possible to deflect air that flows into the air guiding duct via the inlet and is intended to flow out of the outlet into a main flow direction, which runs at an inclination to the surface of the second side of the housing body and is directed toward an underlying surface.

13. The tilting vehicle according to claim 11, wherein the inlet and the outlet of the air guiding unit are arranged offset from one another with respect to a vehicle longitudinal axis, in that the inlet has a smaller spacing from the front wheel than the outlet does.

14. The tilting vehicle according to claim 11, wherein the inlet and the outlet of the air guiding unit are arranged offset from one another with respect to a vehicle vertical axis.

15. The tilting vehicle according to claim 11, wherein the air guiding duct has an arcuate shape.

16. The tilting vehicle according to claim 11, wherein the air guiding duct has a cross section which decreases between the inlet and outlet, from the inlet toward the outlet.

17. The tilting vehicle according to claim 16, wherein the outlet has a nozzle-like contour.

18. The tilting vehicle according to claim 11, wherein the inlet has an opening which steplessly continues an outer surface of the housing body, or wherein the inlet comprises a funnel-like inlet, which projects beyond the outer surface of the housing body.

19. The tilting vehicle according to claim 11, wherein the air guiding device comprises at least two air guiding units, which are arranged running mirror-symmetrically to one another with respect to a plane of symmetry running through the vehicle vertical axis and the vehicle longitudinal axis.

20. The tilting vehicle according to claim 19, wherein the air guiding ducts of the at least two air guiding units cross one another, or wherein the at least two air guiding units extend with their air guiding ducts at a spacing from one another.
